(19) United States
(12) Patent Application Publication
(10) Pub. No.: US 2002/0136977 A1
(43) Pub. Date: Sep. 26, 2002

(54) Developer compositions and processes

(75) Inventors: David H. Pan, Rochester, NY (US); Christopher M. Knapp, Fairport, NY (US); Weizhong Zhao, Webster, NY (US)

Correspondence Address: Patent Documentation Center, Xerox Corporation, 100 Clinton Ave. S., Xerox Square 20th Floor, Rochester, NY, 14644, US

(73) Assignee: Xerox Corporation

(21) Appl. No.: 09/777,423

(22) Filed: Feb. 6, 2001

(51) Int. Cl. G03G 9/135

(52) U.S. Cl. 430/115

(57) ABSTRACT

A liquid developer comprised of a nonpolar liquid, thermoplastic resin, colorant, and a silica charge acceptance additive.

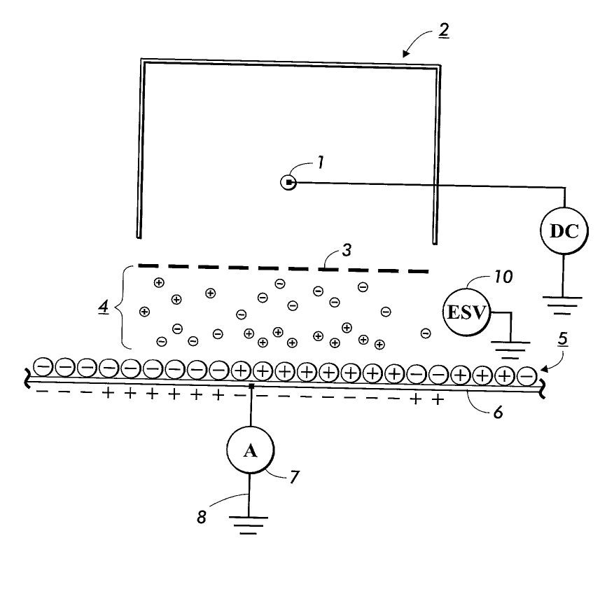

### COPENDING APPLICATIONS AND PATENTS

In copending application U.S. Ser. No. (not yet assigned—D/99429), filed concurrently herewith, the disclosure of which is totally incorporated herein by reference, there is illustrated a liquid developer comprised of a nonpolar liquid, thermoplastic resin, colorant, and a wax charge acceptance additive; U.S. Ser. No. (not yet assigned—D/99447), filed concurrently herewith, the disclosure of which is totally incorporated herein by reference, illustrates a liquid developer comprised of a nonpolar liquid, thermoplastic resin, optional colorant, and an inorganic filler; U.S. Ser. No. (not yet assigned—D/99658), filed concurrently herewith, the disclosure of which is totally incorporated herein by reference, illustrates a liquid developer comprised of a nonpolar liquid, thermoplastic resin, optional colorant, and an alumina charge acceptance additive; U.S. Ser. No. (not yet assigned—D/99661), filed concurrently herewith, the disclosure of which is totally incorporated herein by reference, illustrates a liquid developer comprised of a nonpolar liquid, resin, optional colorant, and an alkaline earth charge acceptance additive; U.S. Ser. No. (not yet assigned—D/A0017), filed concurrently herewith, the disclosure of which is totally incorporated herein by reference, illustrates an imaging apparatus comprising a support member including a support surface for supporting a layer of marking material; a marking material supply apparatus for depositing marking material on the surface of said support member to form a layer of marking material thereon; a charging source for selectively delivering charge species to the layer of marking material in an imagewise manner to form an electrostatic latent image in the layer of marking material, wherein the electrostatic latent image includes image areas of a first charge voltage and nonimage areas of a second charge voltage distinguishable from the first charge voltage; and a separator member for selectively separating portions of the marking material layer in accordance with the latent image in the marking material layer to create a developed image and wherein said marking material is comprised of a liquid developer comprised of a nonpolar liquid, resin, colorant, and a charge acceptance component comprised of a cyclodextrin; and U.S. Ser. No. (not yet assigned—D/A0809), filed concurrently herewith, the disclosure of which is totally incorporated herein by reference, illustrates an imaging apparatus comprising a support member including a support surface for supporting a layer of marking material; a marking material supply apparatus for depositing marking material on the surface of said support member to form a layer of marking material thereon; a charging source for selectively delivering charge species to the layer of marking material in an imagewise manner to form an electrostatic latent image in the layer of marking material, wherein the electrostatic latent image includes image areas with a first charge voltage and nonimage areas with a second charge voltage distinguishable from the first charge voltage; and a separator member for selectively separating portions of the marking material layer in accordance with the latent image in the marking material layer to create a developed image and wherein said marking material is comprised of a liquid developer comprised of a nonpolar liquid, resin, colorant, and a charge acceptance component comprised of an aluminum complex.

Illustrated in U.S. Pat. No. 5,627,002, the disclosure of which is totally incorporated herein by reference, is a positively charged liquid developer comprised of a nonpolar liquid, thermoplastic resin particles, pigment, a charge director, and a charge control agent comprised of a cyclodextrin or a cyclodextrin derivative containing one or more organic basic amino groups.

Disclosed in U.S. Pat. No. 5,826,147, the disclosure of which is totally incorporated herein by reference, is an electrostatic latent image development process wherein there is selected an imaging member with an imaging surface containing a layer of marking material and wherein imagewise charging can be accomplished with a wide beam ion source such that free mobile ions are introduced in the vicinity of an electrostatic image associated with the imaging member.

The appropriate components and processes of the above copending applications and patents may be selected for the present invention in embodiments thereof.

### BACKGROUND OF THE INVENTION

This invention is generally directed to liquid developer compositions and processes thereof, and wherein there can be generated improved developed images thereof in bipolar ion charging processes, and reverse charge imaging and printing development (RCP) processes, reference U.S. Pat. No. 5,826,147, the disclosure of which is totally incorporated herein by reference, and wherein the developer contains no charge director, or wherein the developer contains substantially no charge director. Preferably, the liquid developer of the present invention is clear in color and is comprised of a resin, a hydrocarbon carrier, and as a charge acceptor a component with a high dielectric constant, wherein high possesses values of, for example, from about 2.1 to about 15,000, and more specifically colloidal particles, yet more specifically, wherein the charge acceptor component is comprised of a silica.

Also disclosed is an electrostatographic imaging process wherein an electrostatic latent image bearing member containing a layer of marking material, toner particles, or liquid developer as illustrated herein and containing a charge acceptance additive, which additive may be coated on the developer, is selectively charged in an imagewise manner to create a secondary latent image corresponding to the electrostatic latent image on the imaging member. Imagewise charging can be accomplished by a wide beam charge source for introducing free mobile charges or ions in the vicinity of the electrostatic latent image coated with the layer of marking material or toner particles. The latent image causes the free mobile charges or ions to flow in an imagewise ion stream corresponding to the latent image. These charges or ions, in turn, are accepted by the marking material or toner particles, leading to imagewise charging of the marking material or toner particles with the layer of marking material or toner particles itself becoming the latent image carrier. The latent image carrying toner layer is subsequently developed by selectively separating and transferring image areas of the toner layer to a copy substrate for producing an output document.

The present invention thus in embodiments relates to an imaging apparatus, wherein an electrostatic latent image including image and nonimage areas is formed in a layer of marking material, and further wherein the latent image can be developed by selectively separating portions of the latent image bearing layer of the marking material such that the image areas reside on a first surface and the nonimage areas reside on a second surface. In an embodiment, the invention relates to an image development apparatus, comprising a system for generating a first electrostatic latent image on an imaging member, wherein the electrostatic latent image includes image and non-image areas having distinguishable charge potentials, and a system for generating a second electrostatic latent image on a layer of marking materials situated adjacent the first electrostatic latent image on the imaging member, wherein the second electrostatic latent image includes image and non-image areas having distinguishable charge potentials of a polarity opposite to the charge potentials of the charged image and non-image areas in the first electrostatic latent image.

The liquid developers and processes of the present invention possess a number of advantages including the development and generation of images with excellent image quality, the avoidance of a charge director, the use of the developers in a reverse charging development process, excellent, for example about 90 to about 98 percent, image transfer, and the avoidance of complex chemical charging of the developer. Poor transfer can, for example, result in poor solid area coverage if insufficient toner is transferred to the final substrate and can also cause image defects such as smears and hollowed fine features. Conversely, overcharging the toner particles can result in low reflective optical density images, poor color richness or less than desired chroma since only a few very highly charged particles can discharge all the charge on the dielectric receptor causing too little toner to be deposited. To overcome or minimize such problems, the liquid toners, or developers and processes of the present invention were arrived at after extensive research. Other advantages are as illustrated herein and also include minimal or no image blooming, the generation of excellent solid area images, minimal or no developed image character defects, the enablement of clear, or colorless liquid developers, and the like.

### PRIOR ART

A latent electrostatic image can be developed with toner particles dispersed in an insulating nonpolar liquid. These dispersed materials are known as liquid toners or liquid developers, and in some instances marking materials. The latent electrostatic image may be generated by providing a photoconductive imaging member or layer with a uniform electrostatic charge, and developing the image with a liquid developer, or colored toner particles dispersed in a nonpolar liquid which generally has a high volume resistivity in excess of 10⁹ ohm-centimeters, a low dielectric constant, for example below about 3, and a moderate vapor pressure. Generally, the toner particles are less than about 30 μm (microns) average by area size as measured with the Malvern 3600E-particle sizer.

U.S. Pat. No. 5,019,477, the disclosure of which is totally incorporated herein by reference, discloses a liquid electrostatic developer comprising a nonpolar liquid, thermoplastic resin particles, and a charge director. The ionic or zwitterionic charge directors illustrated may include both negative charge directors, such as lecithin, oil-soluble petroleum sulfonates and alkyl succinimide, and positive charge directors such as cobalt and iron naphthanates. The thermoplastic resin particles can comprise a mixture of (1) a polyethylene homopolymer or a copolymer of (i) polyethylene and (ii) acrylic acid, methacrylic acid or alkyl esters thereof, wherein (ii) comprises 0.1 to 20 weight percent of the copolymer; and (2) a random copolymer (iii) of vinyl toluene and styrene and (iv) butadiene and acrylate. As the copolymer with polyethylene and methacrylic acid or methacrylic acid, alkyl esters, NUCREL® may be selected.

U.S. Pat. No. 5,030,535, the disclosure of which is totally incorporated herein by reference, discloses a liquid developer composition comprising a liquid vehicle, a charge additive and toner pigmented particles. This toner particle may usually contains pigment particles and a resin selected from the group consisting of polyolefins, halogenated polyolefins and mixtures thereof. The liquid developers can be prepared by first dissolving the polymer resin in a liquid vehicle by heating at temperatures of from about 80° C. to about 120° C., adding pigment to the hot polymer solution and attriting the mixture, and then cooling the mixture whereby the polymer becomes insoluble in the liquid vehicle, thus forming an insoluble resin layer around the pigment particles.

Moreover, in U.S. Pat. No. 4,707,429, the disclosure of which is totally incorporated herein by reference, there are illustrated, for example, liquid developers with an aluminum stearate charge adjuvant. Liquid developers with charge directors are also illustrated in U.S. Pat. No. 5,045,425. Also, stain elimination in consecutive colored liquid toners is illustrated in U.S. Pat. No. 5,069,995. Further, of interest with respect to liquid developers are U.S. Pat. Nos. 5,034,299; 5,066,821 and 5,028,508, the disclosures of which are totally incorporated herein by reference.

Lithographic toners with cyclodextrins as antiprecipitants, and silver halide developers with cyclodextrins are known, reference U.S. Pat. Nos. 5,409,803, and 5,352,563, the disclosures of which are totally incorporated herein by reference.

Illustrated in U.S. Pat. No. 5,306,591, the disclosure of which is totally incorporated herein by reference, is a liquid developer comprised of a liquid component, thermoplastic resin; an ionic or zwitterionic charge director, or directors soluble in a nonpolar liquid; and a charge additive, or charge adjuvant comprised of an imine bisquinone; in U.S. Statutory Invention Registration No. H1483 there is described a liquid developer comprised of thermoplastic resin particles, and a charge director comprised of an ammonium AB diblock copolymer, and in U.S. Pat. No. 5,307,731 there is disclosed a liquid developer comprised of a liquid, thermoplastic resin particles, a nonpolar liquid soluble charge director, and a charge adjuvant comprised of a metal hydroxycarboxylic acid, the disclosures of each of these patents, and the Statutory Registration being totally incorporated herein by reference.

### BRIEF DESCRIPTION OF THE FIGURES

The FIGURE illustrates a charging voltage test device.

### SUMMARY OF THE INVENTION

Examples of features of the present invention include:

It is a feature of the present invention to provide a liquid developer with many of the advantages illustrated herein.

Another feature of the present invention resides in the provision of a liquid developer capable of modulated particle charging with, for example, corona ions for image quality optimization.

It is a further feature of the invention to provide positively charged, and/or negatively charged liquid developers, especially colorless or clear in color developers, wherein there are selected as charge acceptance agents or charge acceptance additives silicas.

It is still a further feature of the invention to provide positively and negatively charged liquid developers wherein developed image defects, such as smearing, loss of resolution and loss of density, and color shifts in prints having magenta images overlaid with yellow images are eliminated or minimized, and wherein the charge level of negative and positive polarities are balanced or substantially equal.

Also, in another feature of the present invention there are provided positively charged liquid developers with certain charge acceptance agents that are in embodiments superior to liquid developers with no charge director in that they can be selected for RCP development, reference U.S. Pat. No. 5,826,147, the disclosure of which is totally incorporated herein by reference, and wherein there can be generated high quality images.

Furthermore, in another feature of the present invention there are provided liquid toners that enable excellent image characteristics, and which toners enhance the positive charge of the resin selected, such as ELVAX®, based resins.

These and other features of the present invention can be accomplished in embodiments by the provision of liquid developers.

Aspects of the present invention relate to a liquid developer comprised of a nonpolar liquid, thermoplastic resin, colorant, and a silica charge acceptance additive; a developer wherein the charge acceptance agent or additive is a fumed silica; a developer wherein the charge acceptance additive is amorphous, microcrystalline, microporous, precipitated silicas, fumed silicas, untreated silicas, organosilane treated silicas including dimethyldichlorosilane treated silica, hexamethyldisilazane treated silicas, polydimethylsiloxane treated silicas, silicas treated with amino functional polydimethylsiloxane, silicas treated with a carboxylic acid functional polydimethylsiloxane, or coated silicas; a liquid developer wherein the liquid has a viscosity of from about 0.5 to about 500 centipoise and resistivity equal to or greater than 5×10⁹, and the thermoplastic resin particles have a volume average particle diameter of from about 0.1 to about 30 microns; a developer wherein the resin is a copolymer of ethylene and methacrylic acid; a developer wherein the colorant is present in an amount of from about zero (0) to about 60 percent by weight based on the total weight of the developer solids; a developer wherein the colorant is carbon black, cyan, magenta, yellow, blue, green, orange, red, violet and brown, or mixtures thereof; a developer wherein the charge acceptance agent is present in an amount of from about 0.05 to about 15 weight percent based on the weight of the developer solids of resin, colorant, and charge acceptance agent; a developer wherein the silica possesses a particle size of from about 5 to about 500 nanometers; a developer wherein the silica possesses a BET of from about 30 to about 500 m²/gram; a developer wherein the silica possesses a density of from about 1.2 to about 4.0 g/cm³; a developer wherein the charge acceptance component possesses a high dielectric constant of from about 2.1 to about 15,000; a developer wherein the liquid for the developer is an aliphatic hydrocarbon; a developer wherein the aliphatic hydrocarbon is a mixture of branched hydrocarbons of from about 8 to about 16 carbon atoms, or a mixture of normal hydrocarbons of from about 8 to about 16 carbon atoms; a developer wherein the aliphatic hydrocarbon is a mixture of branched hydrocarbons of from about 8 to about 16 carbon atoms; a developer wherein the resin is an alkylene polymer, a styrene polymer, an acrylate polymer, a polyester, or mixtures or copolymers thereof; a developer wherein the resin is poly(ethylene-co-vinylacetate), poly(ethylene-co-methacrylic acid), poly(ethylene-co-acrylic acid), or poly(propoxylated bisphenol) fumarate; a developer wherein the resin is selected from the group consisting of alpha-olefin/vinyl alkanoate copolymers, alpha-olefin/acrylic acid copolymers, alpha-olefin/methacrylic acid copolymers, alpha-olefin/acrylate ester copolymers, alpha-olefin/ methacrylate ester copolymers, copolymers of styrene/n-butyl acrylate or methacrylate/acrylic or methacrylic acid, and unsaturated ethoxylated and propoxylated bisphenol A polyesters; a developer wherein the developer further contains a charge additive comprised of a mixture of I. a nonpolar liquid soluble organic aluminum complex that has been rendered insoluble by chemical bonding to the toner resin or by adsorption to the toner particles, II. a nonpolar liquid soluble organic phosphate mono and diester mixture derived from phosphoric acid and isotridecyl alcohol that has been rendered insoluble by bonding to the insoluble organic aluminum complex and, or mixtures thereof of the formulas

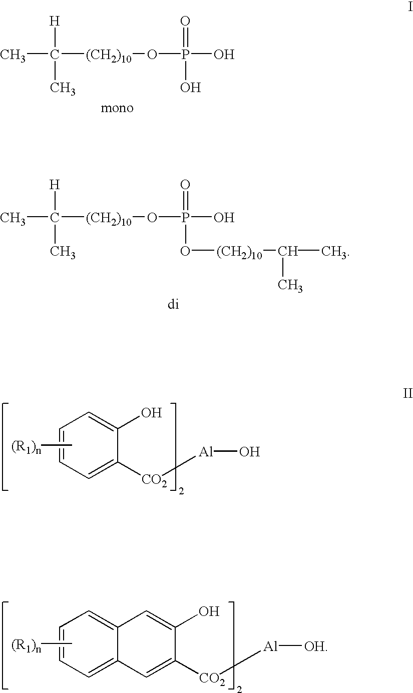

wherein R₁ is selected from the group consisting of hydrogen and alkyl, and n represents a number; a developer wherein the developer further includes a charge adjuvant; a positively, or negatively charged clear or slightly colored liquid developer comprised of a nonpolar liquid, resin, and a charge acceptance agent comprised of a silica; a developer wherein the silica is a fumed silica; a developer wherein the silica is a fumed silica generated from a silicon dioxide by the flame hydrolysis of silicon tetrachloride; a developer wherein the silica is untreated, treated, or coated silicon dioxide; a developer further containing a colorant; a developer comprised of from about 1 to about 20 percent solids of from about 0 to about 60 weight percent colorant, from about 0.05 to about 15 weight percent charge acceptance additive, and from about 35 to about 99.95 weight percent resin, and wherein the developer also contains from about 80 to about 99 weight percent of a nonpolar liquid; a developer comprised of from about 5 to about 15 percent by weight of toner solids comprised of from about 15 to about 55 weight of colorant, from about 0.05 to about 7 percent by weight of charge acceptance additive, and from about 38 to about 85 percent by weight of resin, and wherein the developer further contains from about 85 to about 95 percent by weight of a nonpolar liquid; a developer comprised of a liquid, thermoplastic resin, colorant, and a silica; a developer wherein the liquid is a nonpolar liquid; a liquid developer comprised of a nonpolar liquid, thermoplastic resin, colorant, and a fumed silica; and liquid developers comprised of a nonpolar liquid, resin, preferably thermoplastic resin, and as a charge acceptor a silica, especially a fumed silica. In embodiments thereof of the present invention the liquid developers can be charged in a device which first charges the developer to a first polarity, such as a positive polarity, followed by a second charging with a second charging device to reverse the developer charge polarity, such as to a negative polarity in an imagewise manner. Subsequently, a biased image bearer (IB) separates the image from the background corresponding to the charged image pattern in the toner, or developer layer. Thus, the liquid developers are preferably charged by bipolar ion charging (BIC) rather than with chemical charging.

The charge acceptance/capture additives, such as the fumed silicas, illustrated herein capture both positive and negative ions. Although not being desired to be limited by theory, it is believed that the treated or untreated silica particle may have many different types of functional groups on the surface, and usually the untreated silica particles are considered hydrophilic due to surface silanol (Si—OH) groups. The surface area of silica particles can be treated with a variety of components, such as organosilanes, polydimethylsiloxanes, and functional polydimethylsiloxanes. One can treat the silica surface by chemically anchoring thereto a moiety with an amine, a carboxylic acid or the like functionality. The surface treatment can change hydrophilic silica into silica with predominantly hydrophobic characteristics. Even with various surface treatments, there usually exist some surface hydroxy groups at the silica surface.

The amine treated silica contains non-bonded electron pairs on neutral nitrogen atoms (usually amine functional groups but not limited thereto) and which reside at the surface of the silica particles capture positive ions from the corona effluent by forming covalent or coordinate covalent (dative) bonds with these positive ions. The neutral nitrogen atom in the silica then becomes a positively charged nitrogen atom, and therefore, the silica charge acceptor itself becomes positively charged. Since this positively charged silica particle resides in the immobile toner particle of primarily resin and colorant and not in the mobile phase or liquid carrier, the immobile toner layer itself on a dielectric surface becomes positively charged in an imagewise manner dependent upon the charge acceptor concentration. Since the charge acceptor concentration can be the same throughout the toner layer, it is the amount of toner at a given location in the toner layer that governs the amount of charge acceptor and charge at that location. The amount of charge at a given location then results in differential development (due to different potentials) in accordance with the imagewise pattern deposited on the dielectric surface.

In addition to the above-described nitrogen (positive) charge acceptance mechanism, two other mechanisms may coexist with a silica charge acceptor, with or without nitrogen groups present. These mechanisms involve corona ion-acceptance (involving ion polarities) or acceptance of ions derived from the interaction of corona ions with other components in the toner layer. One mechanism involves the hydroxyl groups (Si—OH), present at the surface of silica particle, which can capture either positive or negative corona effluent ions or species derived therefrom. In regard to the hydroxyl charge (ion) acceptance mechanism, it is believed that non-bonded electron pairs on one or more of the oxygen atoms in adjacent hydroxyl groups can bond positive ions from the corona effluent or from species derived therefrom, from which there results a positive charge dispersed on one or more hydroxyl oxygen atoms. Although the strength of a hydroxyl oxygen-positive ion bond may not be as large as that of the amine nitrogen-positive ion bond, multiple oxygen atoms can participate at any given instant in time to complex the positive ion thereby resulting in a sufficient bonding force to acquire permanent positive charging. Optionally, the positive ion from the corona effluent or from species derived therefrom can bind to only one hydroxyl oxygen atom at any instant in time, however, the positive ion can then migrate around all the hydroxyl oxygen atoms surrounding the surface of silica particle thereby providing positive charge stability by a charge dispersal mechanism. Also, in the hydroxyl oxygen-positive ion bonding mechanism, the hydroxyl group hydrogen atom is further capable of hydrogen bonding to negative ions originating from the corona effluent or from species derived therefrom. Thus, the hydroxyl group itself is ambivalent in its ability to chemically bind positive and negative ions.

In the hydroxyl hydrogen bonding mechanism, hydrogen bonding is an on again-off again mechanism, meaning that when one hydrogen bond forms and then breaks there is an adjacent hydroxyl hydrogen atom that replaces the first broken hydrogen bond so that hydrogen bonding charge dispersion occurs to again provide charge stability by a charge dispersal mechanism. In the second mechanism, corona ion fragments (either positive or negative polarity) or species derived therefrom that are small enough can become physically entrapped inside the microporous silica particles resulting in a charged silica and hence again a charged toner layer. This ion trapping mechanism is specific to the steric size of the ion emanating from the corona effluent or from species derived therefrom. Ions should be able to fit or locate into the cavity opening to be entrapped, therefore, ions too large cannot enter the cavity opening, will not be entrapped and will not charge the toner layer by this mechanism. Ions that are too small to rapidly pass into and out of the silica pores and are not entrapped for a significant time period, will not, it is believed, charge the toner layer by the aforementioned entrapment mechanism. These inappropriately sized ions, however, could ultimately charge the toner layer by other charging mechanisms as indicated herein. The possibility exists is that some of the corona effluent ions have first interacted with other toner layer components to produce secondary ions wherein these secondary ions then become captured by the silica charge acceptance molecules. However, any secondary ion formation that might occur should not be too extensive since there resulted no degradation of the polymeric toner resin or the colorant during the toner layer charging process. The toner layer retains its integrity and the colorant its color strength.

Although not being desired to be limited by theory, it is believed that the silicas have a higher dielectric constant than the surrounding materials, such as the toner resin and hydrocarbons with a dielectric constant of about 2. The corona ion effluent is usually directed toward the region of higher dielectric constant, rather than uniformly distributed at the surface of a composite material. The corona ions, once interacted with silica particles in the toner, can be adsorbed onto the surface of the charge acceptance additive. Considering the situation of a DC corona (ions of one polarity), the ions move along the field lines (produced between the corotron device and ground plane, and distorted by the presence of the dielectric particle) to charge the particle. For a fixed external applied field, a saturation charge Q_{P}, the Pauthenier limit, is reached when the attractive field due to the field distortion equals the repulsive field due to the charge on the particle

Q_{P}=4π∈₀E₀r²[3∈ᵣ/(∈ᵣ+2)],

where ∈ᵣ is the relative permittivity of the dielectric particle with respect to its surrounding medium and r is the particle radius. [3∈ᵣ/(∈ᵣ+2)] varies between 3 for a conducting particle (often dark-colored) with its infinite dielectric constant and 1 for an insulator with a dielectric constant of unity. The relative dielectric constant of insulating materials range between one and ten thus the dependence of Q_{P} on dielectric constant is as much as a factor of 2.5 enhancement for ∈ᵣ=10. The Pauthenier charging does not account for the chemistry of the toner particle, and it is postulated that certain particle surface functional groups may play a role in ion charge acceptance in liquid developers. Silica particles near the surface of the liquid toner particle may (1) increase surface ∈ᵣ of the particle, (2) create a resin/silica interface for capturing corona ions, and (3) provide functional groups for acid-base interactions with corona ions. Also, that the highly mobile conductive species in the continuous phase of the liquid developer can inhibit reversible positive or negative ion charging, which silica particles incorporated in the toner particles, should not generate a conductive species in the continuous phase. In addition, the high-resolution RCP development process requires a high-solids toner cake of a very low lateral conductivity, and thereby limiting the use of conductive materials as CAA.

While not being desired to be limited by theory, although similar to the function of charge control agents in chemically charged liquid developers in that charge acceptance agents in ion-charged liquid developers are directly involved in charging liquid developers, capturing charge using a charge acceptance agent versus a charge control agent is different mechanistically. A first difference resides in the origin and location of the species reacting with a charge acceptance agent versus the origin and location of the species reacting with a charge control agent. The species reacting with a charge acceptance agent usually originate in the corona effluent, which after impinging on the toner layer, become trapped in the solid phase thereof. The species reacting with a charge control agent, that is the charge director, originates by purposeful formulation of the charge director into the liquid developer and remains soluble in the liquid phase of the toner layer. Both the charge acceptance agent (in BIC-RCP developers) and the charge control additive or agent (in chemically charged developers) are insoluble in the liquid developer medium and reside on and in the toner particles, but charge directors, used only in chemically charged developers, dissolve in the developer medium. A second difference between a charge acceptance agent and a charge control agent is that charge directors in chemically charged liquid developers charge toner particles to the desired polarity, while at the same time capturing the charge of opposite polarity so that charge neutrality is always maintained during this chemical equilibrium process. Charge separation occurs only later when the developer is placed in an electric field during development. In a BIC-RCP development process, the corona effluent used to charge the liquid developer is generated from a corona generating device and the dominant polarity of the effluent is fixed by the device. Corona ions first reach the surface of the toner layer, move through the liquid phase, and are adsorbed onto the toner particle and captured by the charge acceptance agent. The mobile or free corona ions in the liquid phase rapidly migrate to the ground plane. Some of these mobile ions may include counterions, if counterions are formed in the charging process. Counterions bear the opposite polarity charge versus the charged toner particles in the developer. The corona ions captured by the charge acceptance agent in or on the toner charge the developer to the same polarity as the dominant polarity charge in the corona effluent. The ion-charged liquid developer particles remain charged and most counterions, if formed in the process, exit to the ground plane so fewer counter charges remain in the developer layer. Electrical neutrality or equilibrium is not attained in the BIC-RCP development process and development is not interfered with by species containing counter charges.

The slightly soluble charge acceptance agent initially resides in the liquid phase, but prior to charging the toner layer the charge acceptance agent deposits on the toner particle surfaces. The concentration of charge acceptor in the nonpolar solvent is believed to be close to the charge acceptor insolubility limit at ambient temperature especially in the presence of toner particles. The adsorption affinity between soluble charge acceptor and insoluble toner particles is believed to accelerate charge acceptor adsorption such that charge acceptor insolubility occurs at a lower charge acceptor concentration versus if toner particles were not present. When the insoluble or slightly soluble charge acceptors accept (chemically bind) ions from the impinging corona effluent (BIC) or from species derived therefrom, there is obtained a net charge on the toner particles in the liquid developer. Since the toner layer contains charge acceptors capable of capturing both positive and negative ions, the net charge on the toner layer is not determined by the charge acceptor but instead is determined by the predominant ion polarity emanating from the corona. Corona effluents rich in positive ions give rise to charge acceptor capture of more positive ions and therefore provide a net positive charge to the toner layer. Corona effluents rich in negative ions give rise to charge acceptor capture of more negative ions, and therefore, provide a net negative charge to the toner layer.

The difference in the charging mechanism of a charge acceptance agent versus a charge control agent as illustrated herein is that after charging a liquid developer via the standard charge director (chemical charging) mechanism, the developer contains an equal number of charges of both polarity. An equal number of charges of both polarities in the developer hinders reverse charge imaging, therefore adding a charge director to the developer before depositing the uncharged developer onto the dielectric surface is undesirable. However, if corona ions in the absence of a charge director are used to charge the toner layer, the dominant ion polarity in the effluent will be accepted by the toner particles to a greater extent resulting in a net toner charge of the desired polarity and little if any counter-charged particles. When the toner layer on the dielectric receiver has more of one kind (positive or negative) of charge on it, reverse charge imaging is facilitated.

Examples of charge acceptance additives present in various effective amounts of, for example, from about 0.001 to about 15, and more specifically, from about 0.01 to about 7 weight percent or parts, based on the total weight percent of the resin solids, other charge additives, colorant, and silica, and wherein the total of all solids is about 1 to about 20 percent and the total of non-polar liquid carriers is about 80 to about 99 percent based on the weight of the total liquid developer. The toner solids contain about 1 to about 7 weight percent silica, about 15 to about 60 weight percent colorant, about 33 to about 83 weight percent resin include amorphous, microcrystalline, microporous, and precipitated silicas, fumed silicas, untreated silicas, organosilane treated silicas including dimethyldichlorosilane treated silica, hexamethyldisilazane treated silicas, polydimethylsiloxane treated silicas, silicas treated with amino functional polydimethylsiloxane, silicas treated with carboxylic acid functional polydimethylsiloxane, coated silicas and the like, inclusive in embodiments of toner silicas and coated silicas illustrated in copending applications U.S. Ser. No. 09/132,623, “Toner Compositions”, and U.S. Ser. No. 09/132,185, “Toner Compositions”, and U.S. Pat. No. 6,004,714, the disclosures of which are totally incorporated herein by reference.

Of importance with respect to the present invention is the presence in the liquid developer of the silica charge acceptor which functions to, for example, increase the Q/M of both positive and negatively charged developers. The captured charge, Q=fCV where C is the capacitance of the toner layer, V is the measured surface voltage, and f is a proportionality constant which is dependent upon the distribution of captured charge in the toner layer. M in Q/M is the total mass of the toner solids and wherein it is believed that all charges are associated with toner particles.

In embodiments of the present invention, the charge acceptance agents are selected in various effective amounts, such as for example from about 0.01 to about 10, and preferably from about 1 to about 7 weight percent.

Examples of liquid carriers or components selected for the developers of the present invention include a liquid with, for example, an effective viscosity of, for example, from about 0.5 to about 500 centipoise, and preferably from about 1 to about 20 centipoise, a resistivity of, for example, equal to or greater than, for example, 5×10⁹ ohm/cm, such as 5×10¹³, a dielectric constant of, for example, below 3 in embodiments, and a vapor pressure at 25° C. of, for example, about 10 Torr in embodiments. Preferably, the liquid selected is a branched chain aliphatic hydrocarbon. A nonpolar liquid of the ISOPAR® series (manufactured by the Exxon Corporation) may also be used for the developers of the present invention. These hydrocarbon liquids are considered narrow portions of isoparaffinic hydrocarbon fractions with extremely high levels of purity. For example, the boiling range of ISOPAR G® is between about 157° C. and about 176° C.; ISOPAR H® is between about 176° C. and about 191° C.; ISOPAR K® is between about 177° C. and about 197° C.; ISOPAR L® is between about 188° C. and about 206° C.; ISOPAR M® is between about 207° C. and about 254° C.; and ISOPAR V® is between about 254.4° C. and about 329.4° C. ISOPAR L® has a mid-boiling point of approximately 194° C. ISOPAR M® has an auto ignition temperature of 338° C. ISOPAR G® has a flash point of 40° C. as determined by the tag closed cup method; ISOPAR H® has a flash point of 53° C. as determined by the ASTM D-56 method; ISOPAR L® has a flash point of 61° C. as determined by the ASTM D-56 method; and ISOPAR M® has a flash point of 80° C. as determined by the ASTM D-56 method.

While the ISOPAR® series liquids may be the preferred liquids for use as dispersant in the liquid developers of the present invention, the desirable characteristics of viscosity and resistivity may be satisfied with other suitable liquids. Specifically, the NORPAR® series available from Exxon Corporation, the SOLTROL® series available from the Phillips Petroleum Company, and the SHELLSOL® series available from the Shell Oil Company can be selected.

The amount of the liquid employed in the developer of the present invention can be, for example, from about 80 to about 99 percent, and preferably from about 85 to about 95 percent by weight of the total liquid developer. The term dispersion refers, for example, to the complete process of incorporating fine particles into a liquid medium such that the final product is comprised of fine toner particles distributed throughout the medium. Since liquid developers contain fine particles dispersed in a nonpolar liquid, it is often referred to as dispersion. The liquid developer dispersion thus can be comprised of toner particles, or toner solids, and nonpolar liquid. The total solids, which can include resin, other charge additives such as adjuvants, optional colorants, and the silica charge acceptance agent, content of the developer in embodiments is, for example, about 0.1 to about 20 percent by weight, preferably from about 3 to about 17 percent, and more preferably, from about 5 to about 15 percent by weight.

Typical suitable thermoplastic toner resins can be selected for the liquid developers of the present invention in effective amounts, for example, in the range of about 99.9 percent to about 40 percent, and preferably about 80 percent to about 50 percent of developer solids comprised of thermoplastic resin, charge acceptance component, and optional charge additive, and in embodiments other components that may comprise the toner. Generally, developer solids include the thermoplastic resin, colorant, and charge acceptance agent. Examples of resins include ethylene vinyl acetate (EVA) copolymers (ELVAX® resins, E. I. DuPont de Nemours and Company, Wilmington, Del.); copolymers of ethylene and an alpha, beta-ethylenically unsaturated acid selected from the group consisting of acrylic acid and methacrylic acid; copolymers of ethylene (80 to 99.9 percent), acrylic or methacrylic acid (20 to 0.1 percent)/alkyl (C1 to C5) ester of methacrylic or acrylic acid (0.1 to 20 percent); polyethylene; polystyrene; isotactic polypropylene (crystalline); ethylene ethyl acrylate series available as BAKELITE® DPD 6169, DPDA 6182 NATURAL™ (Union Carbide Corporation, Stamford, Conn.); ethylene vinyl acetate resins like DQDA 6832 Natural 7 (Union Carbide Corporation); SURLYN® ionomer resin (E. I. DuPont de Nemours and Company); or blends thereof; polyesters; polyvinyl toluene; polyamides; styrene/butadiene copolymers; epoxy resins; acrylic resins, such as a copolymer of acrylic or methacrylic acid, and at least one alkyl ester of acrylic or methacrylic acid wherein alkyl is 1 to 20 carbon atoms, such as methyl methacrylate (50 to 90 percent)/methacrylic acid (0 to 20 percent)/ethylhexyl acrylate (10 to 50 percent); and other acrylic resins including ELVACITE®acrylic resins (E. I. DuPont de Nemours and Company); or blends thereof.

The liquid developers of the present invention preferably contain a colorant dispersed in the resin particles. Colorants, such as pigments or dyes and mixtures thereof, may be present to render latent images visible.

The colorant may be present in the developer in an effective amount of, for example, from about 0.1 to about 60 percent, and preferably from about 15 to about 60, and in embodiments about 25 to about 45 percent by weight based on the total weight of solids contained in the developer. The amount of colorant used may vary depending on the use of the developer. Examples of pigments which may be selected include carbon blacks available from, for example, Cabot Corporation, FANAL PINK™, PV FAST BLUE™, those pigments as illustrated in U.S. Pat. No. 5,223,368, the disclosure of which is totally incorporated herein by reference; other known pigments; and the like. Dyes that may be selected include food dyes, and other known dyes.

To further increase the toner particle charge and, accordingly, increase the transfer latitude of the toner particles, charge adjuvants can be added to the developer. For example, adjuvants, such as metallic soaps like magnesium stearate or octoate, fine particle size oxides, such as oxides of silica, alumina, titania, and the like, paratoluene sulfonic acid, and polyphosphoric acid, may be added. These types of adjuvants can assist in enabling improved toner charging characteristics, namely, an increase in particle charge that results in improved image development and transfer to allow superior image quality with improved solid area coverage and resolution in embodiments. The adjuvants can be added to the developer in an amount of, for example, from about 0.1 percent to about 15 percent of the total developer solids, and preferably from about 3 percent to about 7 percent of the total weight percent of solids contained in the developer.

The liquid developer of the present invention can be prepared by a variety of processes, such as, for example, mixing in a nonpolar liquid, the thermoplastic resin, charge acceptance component, other optional charge additives, such as charge adjuvants and colorant, heating the mixture to a temperature of from about 40° C. to about 110° C. until a uniform dispersion is formed; adding an additional amount of nonpolar liquid sufficient to decrease the total solids concentration of the developer to about 1 to about 30 percent by weight solids and isolating the developer by, for example, cooling the dispersion to about 10° C. to about 30° C.

In the initial mixture, the resin, charge acceptance component, colorant and charge acceptance additive may be added separately to an appropriate vessel such as, for example, an attritor, heated ball mill, heated vibratory mill, such as a Sweco Mill manufactured by Sweco Company, Los Angeles, Calif., equipped with particulate media for dispersing and grinding, a Ross double planetary mixer manufactured by Charles Ross and Son, Hauppauge, N.Y., or a two roll heated mill, which usually requires no particulate media. Useful particulate media include materials like a spherical cylinder of stainless steel, carbon steel, alumina, ceramic, zirconia, silica and sillimanite. Carbon steel particulate media are particularly useful when colorants other than black are used. A typical diameter range for the particulate media is in the range of 0.04 to 0.5 inch (approximately 1.0 to approximately 13 millimeters).

Sufficient nonpolar liquid is added to provide a dispersion of from about 30 to about 60, and more specifically, from about 35 to about 45 percent solids. This mixture is then subjected to elevated temperatures during the initial mixing procedure to plasticize and soften the resin. The mixture is sufficiently heated to provide a uniform dispersion of all the solid materials of, for example, optional colorant, cyclodextrin charge acceptance component, charge acceptance agent, and resin. However, the temperature at which this is undertaken should not be so high as to degrade the nonpolar liquid or decompose the resin or colorant if present. Accordingly, the mixture in embodiments is heated to a temperature of from about 50° C. to about 110° C., and preferably from about 50° C. to about 80° C. The mixture may be ground in a heated ball mill or heated attritor at this temperature for about 15 minutes to about 5 hours, and preferably about 60 to about 180 minutes.

After grinding at the above temperatures, an additional amount of nonpolar liquid may be added to the dispersion. The amount of nonpolar liquid to be added should be sufficient in embodiments to decrease the total solids concentration of the dispersion to about 10 to about 30 percent by weight.

The dispersion is then cooled to about 10° C. to about 30° C., and preferably to about 15° C. to about 25° C., while mixing is continued until the resin admixture solidifies or hardens. Upon cooling, the resin admixture precipitates out of the dispersant liquid. Cooling is accomplished by methods, such as the use of a cooling fluid like water, glycols such as ethylene glycol, in a jacket surrounding the mixing vessel. Cooling is accomplished, for example, in the same vessel, such as an attritor, while simultaneously grinding with particulate media to prevent the formation of a gel or solid mass; without stirring to form a gel or solid mass, followed by shredding the gel or solid mass and grinding by means of particulate media; or with stirring to form a viscous mixture and grinding by means of particulate media. The resin precipitate is cold ground for about 1 to about 36 hours, and preferably from about 2 to about 4 hours. Additional liquid may be added at any time during the preparation of the liquid developer to facilitate grinding or to dilute the developer to the appropriate percent solids needed for developing. Thereafter, the charge director is added. Other processes of preparation are generally illustrated in U.S. Pat. Nos. 4,760,009; 5,017,451; 4,923,778 and 4,783,389, the disclosures of which are totally incorporated herein by reference.

As illustrated herein, the developers or inks of the present invention can be selected for RCP (Reverse Charge Printing) imaging and printing methods wherein, for example there can be selected an imaging apparatus, wherein an electrostatic latent image and nonimage areas are formed in a layer of the liquid developer marking material illustrated herein, and further wherein the latent image can be developed by selectively separating portions of the latent image bearing layer of the marking material such that the image areas reside on a first surface and the nonimage areas reside on a second surface. In embodiments, there is selected an image development apparatus comprising a system for generating a first electrostatic latent image on an imaging member, wherein the electrostatic latent image includes image and nonimage areas having distinguishable charge potentials, and a system for generating a second electrostatic latent image on a layer of the liquid developer marking composition illustrated herein situated adjacent the first electrostatic latent image on the imaging member, wherein the second electrostatic latent image includes image and nonimage areas having distinguishable charge potentials of a polarity opposite to the charge potentials of the charged image and nonimage areas in the first electrostatic latent image.

Embodiments of the invention will be illustrated in the following nonlimiting Examples, it being understood that these Examples are intended to be illustrative only, and that the invention is not intended to be limited to the materials, conditions, process parameters and the like recited. The toner particles in the liquid developer can range in diameter size of from about 0.1 to about 3 micrometers with the preferred particle size range being from about 0.5 to about 1.5 micrometers. Particle size, when measured, was measured by a Horiba CAPA-700 centrifugal automatic particle analyzer manufactured by Horiba Instruments, Inc., Irvine, Calif.

### CHARGING VOLTAGE TEST

### Charging Voltage Test For Embodiments Using Silicas as Charge Acceptance Agents

An experimental setup for accomplishing a charging test is illustrated in the FIGURE. A thin (5 to 25 micrometers) liquid toner layer 5 is prepared on a flat conductive plate 6. The plate is grounded through a meter 7. The charging wire of the scorotron is represented by 1, the scorotron grid by 3, ions by 4, ground by 8, and electrostatic voltmeter by 10 with DC representing direct current. A charging device, such as a scorotron 2, is placed above the plate. The device can be used to measure the charging current passing through the toner layer or the charging voltage of the toner layer. For a charging voltage test, a meter 7 is not required. A thin (5 to 25 micrometers) liquid toner layer sample is prepared on a flat conductive plate. A scorotron is placed above the sample plate. When the scorotron is turned off, the charged toner layer on the plate is instantly moved to an immediately adjacent location underneath the electrostatic voltmeter (ESV) in order to measure the surface voltage. The ESV 10 is located about 1 to about 2 millimeters above the charged toner layer. A typical test involves first charging the toner layer sample with a scorotron for 0.5 second, and then monitoring the surface voltage decay as a function of time for two minutes. This is accomplished for both positively and negatively charged toner layers.

### Control in Table 1=100 Percent of DuPont RX-76®; No Charge Acceptance Agent

Two hundred seventy (270) grams of NUCREL RX-76®, (a copolymer of ethylene and methacrylic acid with a melt index of about 800, available from E. I. DuPont de Nemours & Company, Wilmington, Del.), and 405 grams of ISOPAR-M® (Exxon Corporation) were added to a Union Process 1S attritor (Union Process Company, Akron, Ohio) charged with 0.1857 inch (4.76 millimeters) diameter carbon steel balls. The mixture was milled in the attritor, which was heated with running steam through the attritor jacket to about 80° C. to about 115° C. for 2 hours. 675 Grams of ISOPAR-M® were added to the attritor at the conclusion of 2 hours, and cooled to 23° C. by running water through the attritor jacket, and the contents of the attritor were ground for an additional 4 hours. Additional ISOPAR-M®, about 900 grams, were added and the mixture was separated from the steel balls.

The liquid developer solids contain 100 percent NUCREL RX-76® toner resin. The solids level is 10.067 percent and the ISOPAR M® level is 89.933 percent of this liquid developer. The liquid developer was used as is.

### EXAMPLE I

### In Table 1=99 Percent of DuPont RX-76®; 1 Percent Fumed Silica Charge Acceptance Agent

Two hundred sixty seven point three (267.3) grams of NUCREL RX-76® (a copolymer of ethylene and methacrylic acid with a melt index of about 800, available from E. I. DuPont de Nemours & Company, Wilmington, Del.), 2.7 grams of fumed silica, available from Aldrich Chemicals as 38,128-4, and 405 grams of ISOPAR-M® (Exxon Corporation) were added to a Union Process 1S attritor (Union Process Company, Akron, Ohio) charged with 0.1857 inch (4.76 millimeters) diameter carbon steel balls. The resulting mixture was milled in the attritor, which was heated with running steam through the attritor jacket to about 80° C. to about 115° C. for 2 hours. 675 Grams of ISOPAR-M® were added to the attritor at the conclusion of 2 hours, and cooled to 23° C. by running water through the attritor jacket, and the contents of the attritor were ground for an additional 4 hours. Additional ISOPAR-M®, about 900 grams, was added and the mixture was separated from the steel balls.

The liquid developer solids contain 99 percent NUCREL RX-76® toner resin and 1 percent fumed silica charge acceptance agent. The solids level is 11.337 percent and the ISOPAR M® level is 88.663 percent of this liquid developer.

Ten point six one (10.61) grams of ISOPAR-M® were added to let down or dilute 79.39 grams of the above liquid developer so that the final liquid developer contains 10 percent solids.

### EXAMPLE II

### In Table 1=97 Percent of DuPont RX-76®; 3 Percent Fumed Silica Charge Acceptance Agent

Two hundred sixty one point nine (261.9) grams of NUCREL RX-76® (a copolymer of ethylene and methacrylic acid with a melt index of about 800, available from E. I. DuPont de Nemours & Company, Wilmington, Del.), 8.1 grams of fumed silica, available from Aldrich Chemicals as 38,128-4, and 405 grams of ISOPAR-M® (Exxon Corporation) were added to a Union Process 1S attritor (Union Process Company, Akron, Ohio) charged with 0.1857 inch (4.76 millimeters) diameter carbon steel balls. The mixture was milled in the attritor, which was heated with running steam through the attritor jacket to about 80° C. to about 115° C. for 2 hours. 675 Grams of ISOPAR-M® were added to the attritor at the conclusion of 2 hours, and cooled to 23° C. by running water through the attritor jacket, and the contents of the attritor were ground for an additional 4 hours. Additional ISOPAR-M®, about 900 grams, was added and the mixture was separated from the steel balls.

The liquid developer solids contain 95 percent NUCREL RX-76® toner resin and 5 percent fumed silica charge acceptance agent. The solids level is 10.458 percent and the ISOPAR M® level is 89.542 percent of this liquid developer.

Three point nine four (3.94) grams of ISOPAR-M® were added to let down 86.06 grams of the above liquid developer so that the final liquid developer contains 10 percent solids.

### EXAMPLE III

### In Table 1=95 Percent of DuPont RX-76®; 5 Percent Fumed Silica Charge Acceptance Agent

Two hundred fifty six point five (256.5) grams of NUCREL RX-76® (a copolymer of ethylene and methacrylic acid with a melt index of about 800, available from E. I. DuPont de Nemours & Company, Wilmington, Del.), 13.5 grams of fumed silica, available from Aldrich Chemicals as 38,128-4, and 405 grams of ISOPAR-M® (Exxon Corporation) were added to a Union Process 1S attritor (Union Process Company, Akron, Ohio) charged with 0.1857 inch (4.76 millimeters) diameter carbon steel balls. The mixture was milled in the attritor, which was heated with running steam through the attritor jacket to about 80° C. to about 115° C. for 2 hours. 675 Grams of ISOPAR-M® were added to the attritor at the conclusion of 2 hours, and cooled to 23° C. by running water through the attritor jacket, and the contents of the attritor were ground for an additional 4 hours. Additional ISOPAR-M®, about 900 grams, was added and the mixture was separated from the steel balls.

The liquid developer solids contain 97 percent of NUCREL RX-76® toner resin and 3 percent fumed silica charge acceptance agent. The solids level is 10.368 percent and the ISOPAR M® level is 89.632 percent of this liquid developer. The liquid developer was used as is.

### CHARGING VOLTAGE TEST RESULTS

To further understand the effect of the charge acceptor on RCP ink charging, the above-described toner layer surface-charging voltage test was employed.

TABLE 1

| | | | | | | Test Results* | | | |
|---|---|---|---|---|---|---|---|---|---|
| | Ink | | | | | Positive | | Negative | |
| Solid Charge | | | | | | | Surface | | Surface |
| | | | Charge | Liquid Phase | | Initial | Voltage | Initial | Voltage |
| | | | Acceptance | Carrier | Charge | Surface | after 5 | Surface | after 5 |
| | Resin | Pigment | Agent | fluid | director | Voltage | seconds | Voltage | seconds |
| Control | 100% | No | No | Isopar M | No | 91 | 54 | −49 | −24 |
| | Nucrel | | | | | | | | |
| | RX-76 | | | | | | | | |
| Example 1 | 99% | No | 1% Fumed | Isopar M | No | 206 | 166 | −219 | −174 |
| | Nucrel | | Silica | | | | | | |
| | hRX-76 | | | | | | | | |
| Example | 97% | No | 3% Fumed | Isopar M | No | 224 | 180 | −215 | −160 |
| II | Nucrel | | Silica | | | | | | |
| | RX-76 | | | | | | | | |
| Example | 95% | No | 5% Fumed | Isopar M | No | 252 | 232 | −222 | −207 |
| III | Nucrel | | Silica | | | | | | |
| | RX-76 | | | | | | | | |

*All tests were carried out using +250 V and −250 V scorotron grid voltages for + and − charging,

Ink (toner) layers with thickness of 15 μm were generated by draw bar coating. Scorotrons were used as charging and recharging devices.

The positive and negative toner layer charge-capturing propensity can be measured by several techniques. One of the most frequently used techniques involves first charging the toner layer with a scorotron for a fixed time, e.g. 2 seconds, and then monitoring the surface voltage decay as a function of time as soon as charging is turned off. This is done for both positively and negatively charged toner layers.

The data in the Control of Table 1 indicate that the ink layer with no charge acceptor captured or accepted negative charge equivalent to a surface voltage of −49 volts and decayed to −24 volts thereof for 5 seconds. However, the same ink layer, when charged positively, captured or accepted +91 volts initially but then the voltage of this control ink layer decayed to 54 volts in 5 seconds.

The data in Example I of Table 1, wherein 1 weight percent fumed silica was used as the charge acceptance agent, indicate that the ink layer, when charged negatively, captured or accepted negative charge equivalent to a surface voltage of −219 volts and decayed to −174 volts thereof for 5 seconds. However, when charged positively, the same ink layer captured or accepted +206 volts and decayed to +166 volts in 5 seconds. When charged negatively, the ink layer containing the 1 weight percent fumed silica charge acceptance agent improved (versus the control without fumed silica) in negative charging level from −49 volts to −219 volts (447 percent improvement). Comparing the decay for the 5 second negative surface voltage in Example I versus the Control indicates that in Example I the 5 second negative surface voltage was −174 volts (725 percent improvement) whereas in the Control the 5 second negative surface voltage was only −24 volts. When charged positively, the ink layer containing the 1 weight percent fumed silica charge acceptance agent improved in positive charging level from +91 volts to +206 volts (226 percent improvement). Comparing the decay for the 5 second positive surface voltage in Example I versus the Control indicates that in Example I the 5 second positive surface voltage was +166 volts (307 percent improvement) whereas in the Control the 5 second positive surface voltage was only +54 volts.

The data in Example II of Table 1, wherein 3 weight percent fumed silica was used as the charge acceptance agent, indicate that the ink layer, when charged negatively, captured or accepted negative charge equivalent to a surface voltage of −215 volts and decayed to −160 volts thereof for 5 seconds. However, when charged positively, the same ink layer captured or accepted +224 volts and decayed to +180 volts in 5 seconds. When charged negatively, the ink layer containing the 3 weight percent fumed silica charge acceptance agent improved (versus the control without fumed silica) in negative charging level from −49 volts to −215 volts (439 percent improvement). Comparing the decay for the 5 second negative surface voltage in Example II versus the Control indicates that in Example II the 5 second negative surface voltage was −160 volts (667 percent improvement) whereas in the Control the 5 second negative surface voltage was only −24 volts. When charged positively, the ink layer containing the 3 weight percent fumed silica charge acceptance agent improved in positive charging level from +91 volts to +224 volts (246 percent improvement). Comparing the decay for the 5 second positive surface voltage in Example II versus the Control indicates that in Example II the 5 second positive surface voltage was +180 volts (333 percent improvement) whereas in the Control the 5 second positive surface voltage was only +54 volts.

The data in Example III of Table 1, wherein 5 weight percent fumed silica was used as the charge acceptance agent, indicate that the ink layer, when charged negatively, captured or accepted negative charge equivalent to a surface voltage of −222 volts and maintained −207 volts thereof for 5 seconds. However, when charged positively, the same ink layer captured or accepted +252 volts and decayed slowly to 232 volts in 5 seconds. When charged negatively, the ink layer containing the 5 weight percent fumed silica charge acceptance agent improved (versus the control without fumed silica) in negative charging level from −49 volts to −222 volts (453 percent improvement). Comparing the decay for the 5 second negative surface voltage in Example III versus the Control indicates that in Example III the 5 second negative surface voltage was −207 volts (863 percent improvement) whereas in the Control the 5 second negative surface voltage was −24 volts. When charged positively, the ink layer containing the 5 weight percent fumed silica charge acceptance agent improved in positive charging level from +91 volts (control without fumed silica) to +252 volts (277 percent improvement). Comparing the decay for the 5 second positive surface voltage in Example III versus the Control indicates that in Example III the 5 second positive surface voltage was +232 volts (430 percent improvement) whereas in the Control the 5 second positive surface voltage was only +54 volts.

Other embodiments and modifications of the present invention may occur to those of ordinary skill in the art subsequent to a review of the present application and the information presented herein; these embodiments, modifications, and equivalents, or substantial equivalents thereof are also included within the scope of the present invention.

What is claimed is:

1. A liquid developer comprised of a nonpolar liquid, thermoplastic resin, colorant, and a silica charge acceptance additive.

2. A developer in accordance with claim 1 wherein said charge acceptance agent or additive is a fumed silica.

3. A developer in accordance with claim 1 wherein said charge acceptance additive is amorphous, microcrystalline, microporous, and precipitated silicas, fumed silicas, untreated silicas, organosilane treated silicas including dimethyldichlorosilane treated silica, hexamethyldisilazane treated silicas, polydimethylsiloxane treated silicas, silicas treated with amino functional polydimethylsiloxane, silicas treated with carboxylic acid functional polydimethylsiloxane, or coated silicas.

4. A liquid developer in accordance with claim 1 wherein said liquid has a viscosity of from about 0.5 to about 500 centipoise and resistivity equal to or greater than 5×10⁹, and said thermoplastic resin particles have a volume average particle diameter of from about 0.1 to about 30 microns.

5. A developer in accordance with claim 1 wherein the resin is a copolymer of ethylene and methacrylic acid.

6. A developer in accordance with claim 1 wherein the colorant is present in an amount of from about zero (0) to about 60 percent by weight based on the total weight of the developer solids.

7. A developer in accordance with claim 1 wherein the colorant is carbon black, cyan, magenta, yellow, blue, green, orange, red, violet and brown, or mixtures thereof.

8. A developer in accordance with claim 1 wherein the charge acceptance agent is present in an amount of from about 0.05 to about 15 weight percent based on the weight of the developer solids of resin, colorant, and charge acceptance agent.

9. A developer in accordance with claim 1 wherein the silica possesses a particle size of from about 5 to about 500 nanometers.

10. A developer in accordance with claim 1 wherein the silica possesses a BET of from about 30 to about 500 m²/gram.

11. A developer in accordance with claim 1 wherein the silica possesses a density of from about 1.2 to about 4.0 g/cm³.

12. A developer in accordance with claim 1 wherein the charge acceptance component possesses a high dielectric constant of from about 2.1 to about 15,000.

13. A developer in accordance with claim 1 wherein the liquid for said developer is an aliphatic hydrocarbon.

14. A developer in accordance with claim 13 wherein the aliphatic hydrocarbon is a mixture of branched hydrocarbons of from about 8 to about 16 carbon atoms, or a mixture of normal hydrocarbons of from about 8 to about 16 carbon atoms.

15. A developer in accordance with claim 13 wherein the aliphatic hydrocarbon is a mixture of branched hydrocarbons of from about 8 to about 16 carbon atoms.

16. A developer in accordance with claim 1 wherein the resin is an alkylene polymer, a styrene polymer, an acrylate polymer, a polyester, or mixtures or copolymers thereof.

17. A developer in accordance with claim 16 wherein the resin is poly(ethylene-co-vinylacetate), poly(ethylene-co-methacrylic acid), poly(ethylene-co-acrylic acid), or poly(propoxylated bisphenol) fumarate.

18. A developer in accordance with claim 16 wherein the resin is selected from the group consisting of alpha-olefin/vinyl alkanoate copolymers, alpha-olefin/acrylic acid copolymers, alpha-olefin/methacrylic acid copolymers, alpha-olefin/acrylate ester copolymers, alpha-olefin/methacrylate ester copolymers, copolymers of styrene/n-butyl acrylate or methacrylate/acrylic or methacrylic acid, and unsaturated ethoxylated and propoxylated bisphenol A polyesters.

19. A developer in accordance with claim 1 wherein the developer further contains a charge additive comprised of a mixture of I. a nonpolar liquid soluble organic aluminum complex that has been rendered insoluble by chemical bonding to the toner resin or by adsorption to the toner particles II. a nonpolar liquid soluble organic phosphate mono and diester mixture derived from phosphoric acid and isotridecyl alcohol that has been rendered insoluble by bonding to the insoluble organic aluminum complex and, or mixtures thereof of the formulas 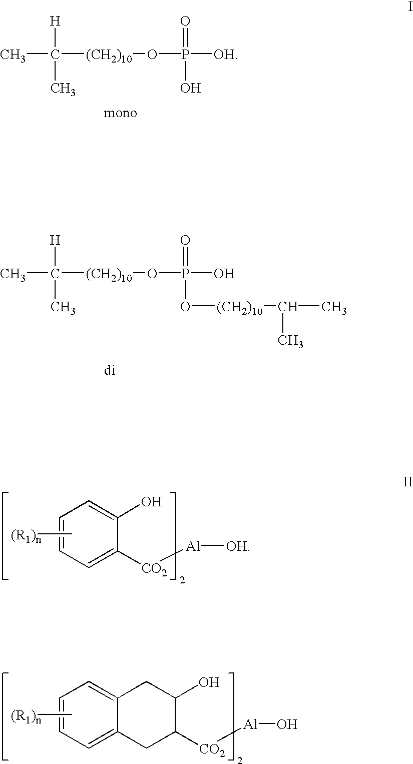
wherein R₁ is selected from the group consisting of hydrogen and alkyl, and n represents a number.

20. A developer in accordance with claim 1 wherein said developer further includes a charge adjuvant.

21. A positively, or negatively charged clear or slightly colored liquid developer comprised of a nonpolar liquid, resin, and a charge acceptance agent comprised of a silica.

22. A developer in accordance with claim 21 wherein the silica is a fumed silica.

23. A developer in accordance with claim 21 wherein the silica is a fumed silica generated from a silicon dioxide by the flame hydrolysis of silicon tetrachloride.

24. A developer in accordance with claim 21 wherein the silica is untreated or treated or coated silicon dioxide.

25. A developer in accordance with claim 21 further containing a colorant.

26. A developer in accordance with claim 1 comprised of from about 1 to about 20 percent solids of from about 0 to about 60 weight percent colorant, from about 0.05 to about 15 weight percent charge acceptance additive, and from about 35 to about 99.95 weight percent resin, and wherein the developer also contains from about 80 to about 99 weight percent of a nonpolar liquid.

27. A developer in accordance with claim 1 comprised of from about 5 to about 15 percent by weight of toner solids comprised of from about 15 to about 55 weight of colorant, from about 0.05 to about 7 percent by weight of charge acceptance additive, and from about 38 to about 85 percent by weight of resin, and wherein the developer further contains from about 85 to about 95 percent by weight of a nonpolar liquid.

28. A developer comprised of a liquid, resin, colorant, and a silica.

29. A developer in accordance with claim 28 wherein said liquid is a nonpolar liquid.

30. A liquid developer comprised of a nonpolar liquid, thermoplastic resin, colorant, and a fumed silica.
